(19) United States
(12) Patent Application Publication
(10) Pub. No.: US 2006/0074840 A1
(43) Pub. Date: Apr. 6, 2006

(54) System and method for tracking print job status

(75) Inventors: Fabio M. Gava, Ladera Ranch, CA (US); Kenneth Stephenson, San Clemente, CA (US); Mustafa Seifi, Irvine, CA (US); Marianne Kodimer, Huntington Beach, CA (US); Harpreet Singh, Orange, CA (US)

Correspondence Address: TUCKER, ELLIS & WEST LLP, 1150 HUNTINGTON BUILDING, 925 EUCLID AVENUE, CLEVELAND, OH, 44115-1475, US

(73) Assignees: Toshiba Corporation; Toshiba Tec Kabushiki Kaisha

(21) Appl. No.: 10/949,043

(22) Filed: Sep. 24, 2004

(51) Int. Cl. G06F 17/30

(52) U.S. Cl. 707/1

(57) ABSTRACT

A system and method to track and display the status of an electronic document submitted through a web-portal to a multifunctional peripheral device. The multifunctional peripheral device receives an electronic document file upon which it is to perform a service and logs the receipt in a central status database. During the processing of the electronic document file, the multifunctional peripheral device continually updates the status information corresponding to that file in the central status database. Through a web-portal, a user selects from a list of recently submitted document files one file for which status information is desired. The multifunctional peripheral device then accesses the central status database, retrieves the file, and displays, via the web-portal, detailed document and status information corresponding to the selected document file.

### BACKGROUND OF THE INVENTION

This invention is directed to a system and method for tracking the status of document processing services. More particularly, this invention is directed to a system and method to allow users to access and track the job status of a data peripheral device via a web portal.

Professionals routinely work with documents or other data while away from their office environment. These professionals often need to generate image data, by scanning a document and then need to distribute or perform other functions on such image data. The professional often submits service requests on the image data through a web-based system where the requests are not immediately processed. For example, the professional desires to print the image data, however they are not able to physically approach the document processing device which is going to or is outputting the data. They have no way of ascertaining the status of his or her submitted request via the web-based connection. That is, the professional cannot be certain that the request was received, is being processed, or was completed. Typically, successful completion of the print request can only be determined by physically viewing the pages printed. Until the request is printed, there exists no means to determine the progress of the print request. Similarly, when submitting a facsimile request, they cannot ascertain the progress of the request over the web-based system without directly contacting the facsimile recipient.

Thus, there is a need for system and method to provide a user with feedback on the progress and status of a service request transmitted using a web-based document processing service.

### SUMMARY OF THE INVENTION

In accordance with the present invention, there is provided a system and method for tracking the status of document processing services.

Further, in accordance with the present invention, there is provided a system and method to allow users to access and track the job status of a data peripheral device via a web portal.

Still further in accordance with the present invention, there is provided a system and method to enable a user to receive feedback on the most recently submitted service requests, displaying the service requests' status as well as detailed information on the completed steps involved in servicing the submitted service requests.

Still yet further in accordance with the present invention, there is provided a method for providing the status of a submitted electronic document on a data peripheral device. The data peripheral device receives data representing an electronic document and a request to perform a service on the electronic document. The data peripheral device then processes the received electronic document according to the type of service requested. During the processing of the electronic document, the data peripheral device stores data representing the status of the electronic document during each step of the processing. An associated user then submits a request to the data peripheral device for a status update on one of the electronic documents being processed by the device. The data peripheral device then retrieves from storage data representing the status of the electronic document. This status information is then transmitted from the data peripheral device to the user over a computer network.

In a preferred embodiment, the method includes the step of displaying to an authenticated user a list of recently submitted electronic documents. The user then selects one of the electronic documents from the list. The data peripheral device then displays, via the computer network, the status of the selected electronic document.

Still further, in accordance with the present invention, there is provided a system for providing the status of a submitted electronic document on a data peripheral device. The system includes means adapted for receiving, on the data peripheral device, data representing an electronic document. The system further includes means adapted for processing the electronic document according to the requested service and means adapted for storing, in associated data storage, each step of the processing of the electronic document performed by the data peripheral device. The system also includes means adapted for receiving, from an associated user, a request for the status of the processing of the electronic document and means adapted for retrieving, by the data peripheral device, data representing the status of the electronic document. The system further includes means adapted for communicating the status data of the requested electronic document from the data peripheral device to the associated user over a computer network.

In a preferred embodiment, the system includes means adapted for displaying to an authenticated user, a list of recently submitted electronic documents. Means adapted for selecting is used by the authenticated user, to select an electronic document from the list of recent electronic documents. The system then uses means adapted for displaying to the associated user the status of the selected electronic document.

Still other advantages, aspects and features of the present invention will become readily apparent to those skilled in the art from the following description wherein there is shown and described a preferred embodiment of this invention, simply by way of illustration of one of the best modes best suited for to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

The subject invention is described with reference to certain parts, and arrangements to parts, which are evidenced in conjunction with the associated drawings, which form a part hereof and not, for the purposes of limiting the same in which:

FIG. 1 is a diagram illustrating a system for providing document status information to users over a computer network according to the present invention;

FIG. 2 is a flowchart of one embodiment for storing status information of service requests received over a computer network;

FIG. 3 is flowchart of one embodiment for presenting status information to users over a computer network according to the present invention; and

FIG. 4 is a sample template for selecting the electronic document file for status query.

### DETAILED DESCRIPTION OF THE PREFERRED EMBODIMENTS

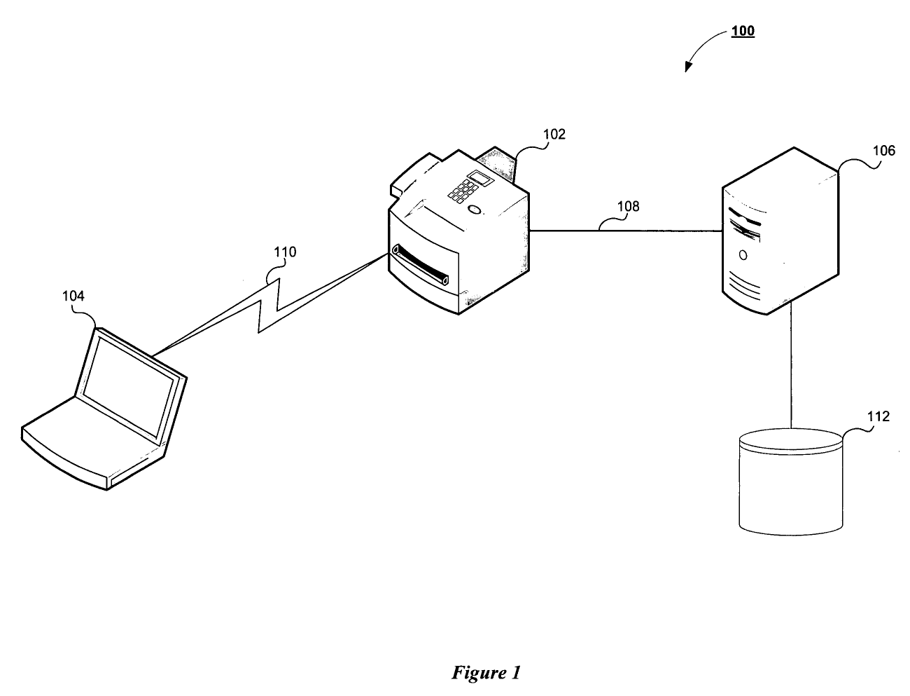

The present invention is directed to a system and method for providing status information of service requests to users over a web-based system. A diagram illustrating the system 100 is shown in FIG. 1. In the present invention, a mobile user is provided access to a multifunctional peripheral device 102 in a non-office environment, such as an airport lounge, hotel or business center. Other non-office environment locations include, but are not limited to, university campuses, conference centers, libraries, and hotels. The user accesses the multifunctional peripheral device 102 via a computer or other suitable interface 104 via a suitable communication link 110, such as the Internet. The user uses at the computer 104 a web-portal that enables the user to access the multifunctional peripheral device 102 and submit service requests or retrieve status information.

The multifunctional peripheral is connected to an associated controller 106 via a suitable communication link 108. It will be appreciated that the controller, while illustrated in the system 100 has being separate from the multifunctional peripheral device 102, it is equally capable of being integrated within the multifunctional peripheral device 102, without departing from the scope of the subject invention. The controller 106 includes an associated storage medium 112 for storing status information corresponding to the multiple service requests received by the multifunctional peripheral device 102. The user is then provided with information about the status of the service requests. The information is provided in any suitable manner known in the art. The information is suitably provided by way of a user interface associated with the multifunctional peripheral device or documentation provided related thereto.

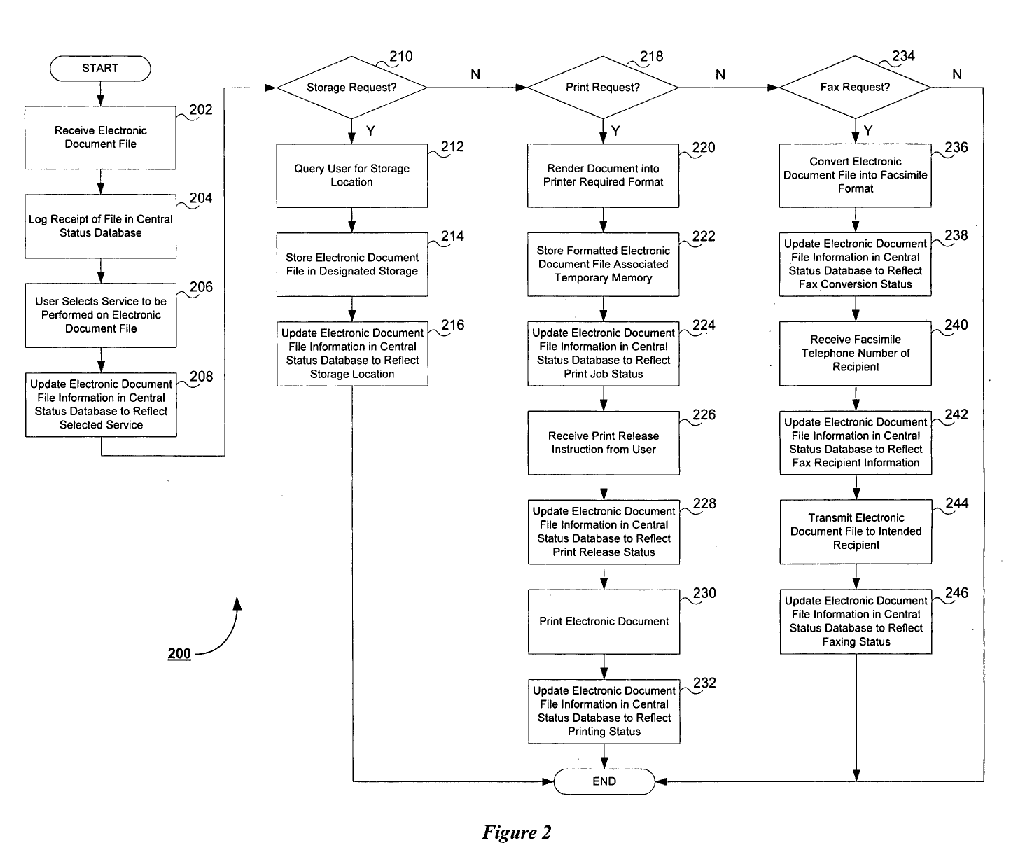

The services provided to the user are those typically provided by multifunctional peripheral devices and associated software. In this invention, the system allows the user to generate image data, such as by scanning a document, transmit the image data via the Internet to the multifunctional peripheral device 102 and then to store the status of the processing of the image data in storage medium 112 for a predetermined time. FIG. 2 illustrates the method by which the multifunctional peripheral device 102 collects and stores status information corresponding to service requests it receives.

As shown in FIG. 2, the flowchart 200 illustrates the method of collecting and storing status information corresponding to facsimile, printing and storage requests. It will be appreciated by those skilled in the art that other suitable services known in the art capable of being performed by a multifunctional peripheral device are equally employable by the subject invention. Beginning at step 202, the multifunctional peripheral device 102 receives an electronic document file in any suitable format, as is well-known in the art. It will be understood by those skilled in the art that the format of the submitted document file is dependent upon the application that generated the file and the subject invention is capable of handling a variety of file formats. The multifunctional peripheral device 102 then logs the receipt of the submitted electronic document file in a central status database. The central status database is any database format known in the art. In the preferred embodiment, the central status database is located on the storage medium 112 communicatively coupled to the controller 106 and/or the multifunctional peripheral device 102.

After receiving the electronic document file, the multifunctional peripheral device 102 waits for the user to select a service to be performed on the file at step 206. It will be appreciated by those skilled in the art that for explanatory purposes, the flowchart 200 illustrates three services offered by the multifunctional peripheral device 102. The skilled artisan will understand that other services are capable of being offered by the multifunctional peripheral device 102 without departing from the scope of the subject invention. Upon determining the requested service, the multifunctional peripheral device 102 updates the status information corresponding to the electronic document file in the central status database at step 208.

When the selected service is determined to be the storage of the document file at step 210, the user is queried for the storage destination at step 212. The electronic document file is then stored in the designated location at step 214. The multifunctional peripheral device 102 then updates the status information corresponding to the electronic document file in the central status database at step 216.

When the selected service is determined to be the printing of the electronic document file at step 218, the multifunctional peripheral device 102 renders the document file into a format capable of being recognized by the multifunctional peripheral device's 102 printer engine at step 220. In the preferred embodiment, the controller 106 of the multifunctional peripheral device 102 performs the rendering process of the print request at step 220. However, it will be understood by those skilled in the art that the rendering of image data into a format suitable for printing is capable of being performed by the user's computer 104 prior to the receipt of the electronic document file by the multifunctional peripheral device 102. The skilled artisan will appreciate that such performance by the computer 104 would preclude the necessity of rendering the image data of the electronic document file by the controller 106 and/or the multifunctional peripheral device 102. The subject invention is adaptable to updating the status of the electronic document file to reflect the rendering by the computer 104 in the central status database.

After rendering, the electronic document file is stored in temporary memory associated with the multifunctional peripheral device 102 at step 220. The multifunctional peripheral device 102 then updates the electronic document file information in the central status database to reflect the completion of the rendering operation and storage of the document file at step 228. For explanatory purposes, updating of the status information is only shown in the flowchart 200 as occurring at step 224, reflecting both the rendering completed and storage completed status of the electronic document file. However, in the preferred embodiment, the status of the electronic file is updated after rendering at step 220 and again after storing the file at step 222.

The multifunctional peripheral device 102 then waits to receive at step 226 the print release instruction from the user. It will be understood by those skilled in the art that the print release instruction is capable of being transmitted via the web-portal or by directly inputting the command at the multifunctional peripheral device 102. The multifunctional peripheral device 102 then updates the status information in the central status database to reflect the receipt of the print release instruction at step 228. At step 230, the multifunctional peripheral device 102 prints the rendered electronic document file using any printing output means known in the art. Such printing means suitably includes, but is not limited to, ink-jet printing, laser-printing and the like. The multifunctional peripheral device 102 then updates the electronic document file information in the central status database to reflect the printing status of the electronic document file at step 232.

When the selected service is determined to be the facsimile transmission of the electronic document file at step 234, the multifunctional peripheral device 102 converts the electronic document file into a facsimile format at step 236. In the preferred embodiment, the controller 106 of the multifunctional peripheral device 102 performs the conversion process of the facsimile request at step 236. However, it will be understood by those skilled in the art that the conversion of image data into a format suitable for facsimile transmission is capable of being performed by the user's computer 104 prior to the receipt of the electronic document file by the multifunctional peripheral device 102. The skilled artisan will appreciate that such performance by the computer 104 would preclude the necessity of converting the image data of the electronic document file by the controller 106 and/or the multifunctional peripheral device 102. The subject invention is adaptable to updating the status of the electronic document file to reflect the conversion by the computer 104 in the central status database.

At step 238, the electronic document file information is updated in the central status database to reflect the conversion status of the file. The user then enters the facsimile telephone number of the recipient, or the telephone numbers of the recipients at step 240. The status information corresponding to the electronic document file is then updated in the central status database at step 242. The multifunctional peripheral device 102 then transmits the electronic document file to the designated recipients at step 244. The central status database is then updated to reflect the facsimile status of the electronic document file at step 246.

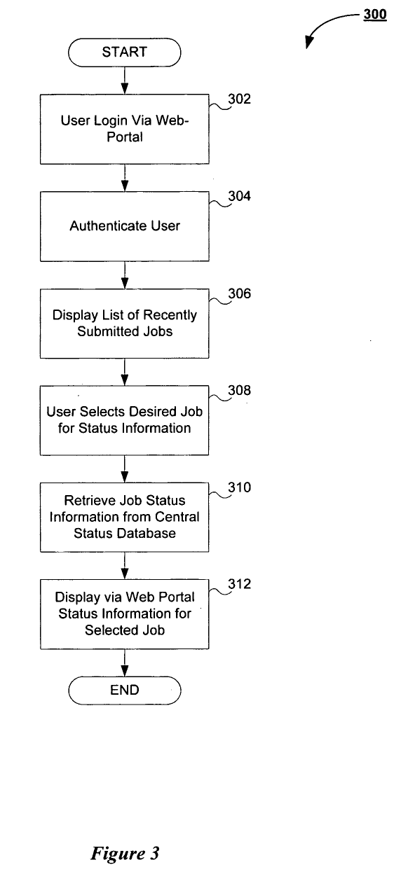

Turning now to FIG. 3, a flowchart 300 illustrates the process by which the user accesses the status of an electronic document file. Beginning at step 302, the user accesses the multifunctional peripheral device 102 by logging into a web-portal. As will be understood by those skilled in the art, the web-portal is any Internet or computer-network based interface protocol known in the art, including, but not limited to, HTTP, FTP, TCP/IP, and the like. The user is authenticated at step 304 using any method of authentication known in the art, such as user-ID and password. At step 306, the multifunctional peripheral device 102 displays, via the web-portal, a list of recently submitted service requests, or pending jobs. In the preferred embodiment, the list includes all requests submitted to the multifunctional peripheral device 102 during the preceding twenty-four hour period. It will be understood by those skilled in the art that the time-frame is capable of being arbitrarily selected by an administrator or the user.

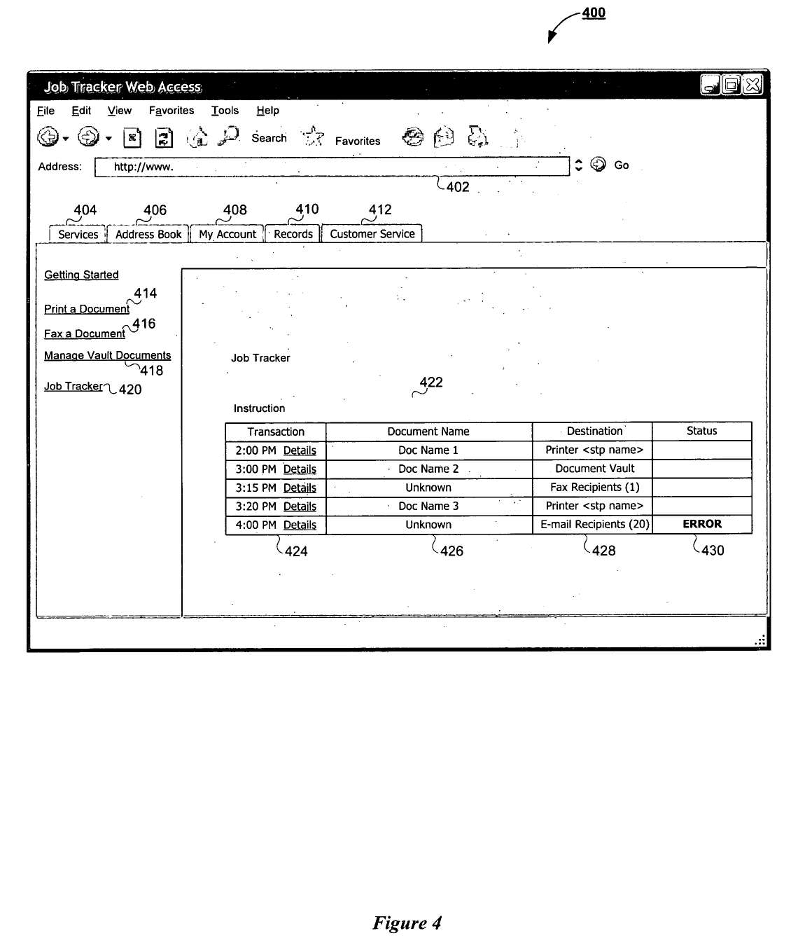

The user then selects from the displayed list a job for which he or she desires to view status information at step 308. The multifunctional peripheral device 102 then retrieves job status information from the central status database corresponding to the selected file at step 310. The retrieved information is then displayed via the web-portal to the user at step 312. FIG. 4 depicts a sample template for selecting the electronic document file for a status query.

Turning now to FIG. 4, there is shown a template 400 illustrating a web-portal access page from which a user is capable of requesting the status information for a particular electronic document file. As will be understood by those skilled in the art, the user accesses the login page of the web-portal by entering in the Internet address in the address bar 402. After successfully logging into the multifunctional peripheral device 102 via the web-portal, the page template 400 is displayed. The user is able to select from services 404, an address book 406, the user account 408, the user records 410, or access customer service 412. When selecting one of the preceding tabs, a corresponding dialog is displayed. As shown in FIG. 4, the services tab 404 has been selected and several options are presented to the user. Shown on the right-side of the screen are HTML links to corresponding services, printing 414, faxing 416, accessing stored documents via the document vault 418, or accessing the job tracker 420.

FIG. 4 illustrates the user selection of the job tracker 420 link. A listing of recently submitted documents is shown in the table 422. The transaction time 424, the document name 426, the destination of the file 428 and a brief status of the file 430 are shown. Available under the transaction time is an HTML link to a more detailed information page corresponding to the particular electronic document file. The user is thereby able to select one of the recently submitted documents from the list 422 and view detailed status information in addition to the status information displayed in the status column of the list 422. Additionally, the user is capable of tracking a particular document throughout the processing of that document by the multifunctional peripheral device 102.

The invention extends to computer programs in the form of source code, object code, code intermediate sources and object code (such as in a partially compiled form), or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed is:

1. A method for providing the status of a submitted electronic document on a data peripheral device comprising the steps of:
receiving, at the data peripheral device, data representative of the electronic document;
receiving, at the data peripheral device, data representative of a requested service to be performed by the data peripheral device on the electronic document;
processing the electronic document in accordance with the data representative of the requested service received by the data peripheral device; and
storing in an associated data storage, at each step of the processing of the electronic document, data representative of the status the electronic document.

2. The method for providing the status of a submitted electronic document on a data peripheral device of claim 1, further comprising the steps of:
receiving, from an associated user, a request for the status of the processing of the electronic document;
retrieving, by the data peripheral device, data representative of the status of the electronic document; and
communicating the data representative of the status of the requested electronic document from the data peripheral device to the associated user over a computer network.

3. The method for providing the status of a submitted electronic document on a data peripheral device of claim 2, further comprising the step of authenticating the associated user.

4. The method for providing the status of a submitted electronic document on a data peripheral device of claim 2, wherein the computer network is the Internet.

5. The method for providing the status of a submitted electronic document on a data peripheral device of claim 2, wherein the request for the status of the electronic document is input using a web portal.

6. The method for providing the status of a submitted electronic document on a data peripheral device of claim 2, further comprising the steps of:
displaying, to the associated user, a list of recent electronic documents submitted to the data peripheral device for processing status of the electronic document;
selecting, by the associated user, an electronic document from the list of recent electronic documents; and
displaying, to the associated user, the status of the selected electronic document.

7. The method for providing the status of a submitted electronic document on a data peripheral device of claim 6, wherein the step of receiving, at the data peripheral device, data representative of the electronic document further comprises the steps of:
rendering the submitted electronic document into a format recognizable to the data peripheral device; and
storing, in an associated memory of the data peripheral device, the submitted electronic document.

8. The method for providing the status of a submitted electronic document on a data peripheral device of claim 7, further comprising the step of printing the submitted electronic document.

9. The method for providing the status of a submitted electronic document on a data peripheral device of claim 6, further comprising the steps of:
converting the submitted electronic document into an appropriate facsimile format;
receiving, from the associated user, destination data representative of a facsimile recipient; and
transmitting the converted electronic document to the facsimile recipient.

10. A system for providing the status of a submitted electronic document on a data peripheral device comprising:
means adapted for receiving, on the data peripheral device, data representative of the electronic document;
means adapted for receiving, on the data peripheral device, data representative of a requested service to be performed by the data peripheral device on the electronic document;
means adapted for processing the electronic document in accordance with the data representative of the requested service received by the data peripheral device; and
means adapted for storing in an associated data storage, at each step of the processing of the electronic document, data representative of the status the electronic document.

11. The system for providing the status of a submitted electronic document on a data peripheral device of claim 10, further comprising:
means adapted for receiving, from an associated user, a request for the status of the processing of the electronic document;
means adapted for retrieving, by the data peripheral device, data representative of the status of the electronic document; and
means adapted for communicating the data representative of the status of the requested electronic document from the data peripheral device to the associated user over a computer network.

12. The system for providing the status of a submitted electronic document on a data peripheral device of claim 11, further comprising means adapted for authenticating the associated user.

13. The system for providing the status of a submitted electronic document on a data peripheral device of claim 11, wherein the computer network is the Internet.

14. The system for providing the status of a submitted electronic document on a data peripheral device of claim 11, wherein the request for the status of the electronic document is input using a web portal.

15. The system for providing the status of a submitted electronic document on a data peripheral device of claim 11, further comprising:
means adapted for displaying, to the associated user, a list of recent electronic documents submitted to the data peripheral device for processing status of the electronic document;
means adapted for selecting, by the associated user, an electronic document from the list of recent electronic documents; and
means adapted for displaying, to the associated user, the status of the selected electronic document.

16. The system for providing the status of a submitted electronic document on a data peripheral device of claim 15, wherein the means adapted for receiving, at the data peripheral device, data representative of the electronic document further comprises:
means adapted for rendering the submitted electronic document into a format recognizable to the data peripheral device; and
means adapted for storing, in an associated memory of the data peripheral device, the submitted electronic document.

17. The system for providing the status of a submitted electronic document on a data peripheral device of claim 16, further comprising means adapted for printing the submitted electronic document.

18. The system for providing the status of a submitted electronic document on a data peripheral device of claim 15, further comprising:
means adapted for converting the submitted electronic document into an appropriate facsimile format;
means adapted for receiving, from the associated user, destination data representative of a facsimile recipient; and
means adapted for transmitting the converted electronic document to the facsimile recipient.

19. A computer-readable medium of instructions for providing the status of a submitted electronic document on a data peripheral device comprising:
instructions for receiving, on the data peripheral device, data representative of the electronic document;
instructions for receiving, on the data peripheral device, data representative of a requested service to be performed by the data peripheral device on the electronic document;
instructions for processing the electronic document in accordance with the data representative of the requested service received by the data peripheral device; and
instructions for storing in an associated data storage, at each step of the processing of the electronic document, data representative of the status the electronic document.

20. The computer-readable medium of instructions for providing the status of a submitted electronic document on a data peripheral device of claim 19, further comprising:
instructions for receiving, from an associated user, a request for the status of the processing of the electronic document;
instructions for retrieving, by the data peripheral device, data representative of the status of the electronic document; and
instructions for communicating the data representative of the status of the requested electronic document from the data peripheral device to the associated user over a computer network.

21. The computer-readable medium of instructions for providing the status of a submitted electronic document on a data peripheral device of claim 20, further comprising instructions for authenticating the associated user.

22. The computer-readable medium of instructions for providing the status of a submitted electronic document on a data peripheral device of claim 20, wherein the computer network is the Internet.

23. The computer-readable medium of instructions for providing the status of a submitted electronic document on a data peripheral device of claim 20, wherein the request for the status of the electronic document is input using a web portal.

24. The computer-readable medium of instructions for providing the status of a submitted electronic document on a data peripheral device of claim 20, further comprising:
instructions for displaying, to the associated user, a list of recent electronic documents submitted to the data peripheral device for processing status of the electronic document;
instructions for selecting, by the associated user, an electronic document from the list of recent electronic documents; and
instructions for displaying, to the associated user, the status of the selected electronic document.

25. The computer-readable medium of instructions for providing the status of a submitted electronic document on a data peripheral device of claim 24, wherein the instructions for receiving, at the data peripheral device, data representative of the electronic document further comprises:
instructions for rendering the submitted electronic document into a format recognizable to the data peripheral device; and
instructions for storing, in an associated memory of the data peripheral device, the submitted electronic document.

26. The computer-readable medium of instructions for providing the status of a submitted electronic document on a data peripheral device of claim 25, further comprising instructions for printing the submitted electronic document.

27. The computer-readable medium of instructions for providing the status of a submitted electronic document on a data peripheral device of claim 24, further comprising:
instructions for converting the submitted electronic document into an appropriate facsimile format;
instructions for receiving, from the associated user, destination data representative of a facsimile recipient; and
instructions for transmitting the converted electronic document to the facsimile recipient.

28. A computer-implemented method for providing the status of a submitted electronic document on a data peripheral device comprising the steps of:
receiving, at the data peripheral device, data representative of the electronic document;
receiving, at the data peripheral device, data representative of a requested service to be performed by the data peripheral device on the electronic document;
processing the electronic document in accordance with the data representative of the requested service received by the data peripheral device; and
storing in an associated data storage, at each step of the processing of the electronic document, data representative of the status the electronic document.

29. The computer-implemented method for providing the status of a submitted electronic document on a data peripheral device of claim 28, further comprising the steps of:
receiving, from an associated user, a request for the status of the processing of the electronic document;
retrieving, by the data peripheral device, data representative of the status of the electronic document; and
communicating the data representative of the status of the requested electronic document from the data peripheral device to the associated user over a computer network.

30. The computer-implemented method for providing the status of a submitted electronic document on a data peripheral device of claim 29, further comprising the step of authenticating the associated user.

31. The computer-implemented method for providing the status of a submitted electronic document on a data peripheral device of claim 29, wherein the computer network is the Internet.

32. The computer-implemented method for providing the status of a submitted electronic document on a data peripheral device of claim 29, wherein the request for the status of the electronic document is input using a web portal.

33. The computer-implemented method for providing the status of a submitted electronic document on a data peripheral device of claim 29, further comprising the steps of:
displaying, to the associated user, a list of recent electronic documents submitted to the data peripheral device for processing status of the electronic document;
selecting, by the associated user, an electronic document from the list of recent electronic documents; and
displaying, to the associated user, the status of the selected electronic document.

34. The computer-implemented method for providing the status of a submitted electronic document on a data peripheral device of claim 33, wherein the step of receiving, at the data peripheral device, data representative of the electronic document further comprises the steps of:
rendering the submitted electronic document into a format recognizable to the data peripheral device; and
storing, in an associated memory of the data peripheral device, the submitted electronic document.

35. The computer-implemented method for providing the status of a submitted electronic document on a data peripheral device of claim 34, further comprising the step of printing the submitted electronic document.

36. The computer-implemented method for providing the status of a submitted electronic document on a data peripheral device of claim 33, further comprising the steps of:
converting the submitted electronic document into an appropriate facsimile format;
receiving, from the associated user, destination data representative of a facsimile recipient; and
transmitting the converted electronic document to the facsimile recipient.
